(19) United States
(12) Patent Application Publication
(10) Pub. No.: US 2003/0235808 A1
(43) Pub. Date: Dec. 25, 2003

(54) Methods, systems, and devices for delivering subliminal messages

(76) Inventor: Anne Hardison, Scottsdale, AZ (US)

Correspondence Address: Steven Thrasher, 391 Sandhill Dr., Richardson, TX, 75080, US

(21) Appl. No.: 10/176,256

(22) Filed: Jun. 20, 2002

(51) Int. Cl. G09B 19/00

(52) U.S. Cl. 434/236; 434/365; 434/307 R

(57) ABSTRACT

The invention provides methods, systems, and devices for delivering a subliminal message. In one embodiment, a subliminal message machine (the machine) communicates with a message playback system that is includes a timer, a memory storage device adapted to receive recorded messages, and an input/output system. The machine provides for the timed, targeted, automatic playing of a subliminal message.

### TECHNICAL FIELD

Generally, the invention relates to psychology, and the field of motivational and educational systems, and more particularly, to the field of subliminal messaging.

### STATEMENT OF A PROBLEM ADDRESSED BY THIS INVENTION

Many people benefit from listening to motivational and educational messages to stimulate positive feelings and improve personal or professional performance. As the use of subliminal message programs has become more popular and accepted, science has begun identifying factors that function as parts of an effective subliminal message program. Regular exposure to a subliminal message (the message) is one important part of a subliminal message program. However, regular exposure to the message is difficult for many people since they must take time from busy schedules to listen to the messages. This increases the chances that a listening habit will be broken, and that the benefits of the message program will be lessened. In addition, many people do not operate on a predictable schedule. These persons can easily forget to listen to a message—such as when on a trip.

A clear mind is another important part of a subliminal message program. However, in the morning, many persons are “rushed” to get ready for work. In the afternoon, they are rushed to complete family tasks, and are typically quite stressed. These distractions and stressors comprise “mental noise” that prevent the user of the subliminal message system from “taking in” the message. Accordingly, many persons who try to adhere to a subliminal message program and who actually listen to the message(s) daily may actually receive few benefits from the message due to distractions. Accordingly, to overcome these and other problems with absorbing subliminal messages, it would be advantageous to provide a user the ability to regularly listen to subliminal messages when the mind is more likely to be clear and receptive to those messages.

### SELECTED OVERVIEW OF SELECTED EMBODIMENTS

The invention provides technical and operational advantages as methods, systems, and devices that deliver subliminal messages. In one embodiment, the invention is a subliminal message machine that includes a timer (the machine). Generally, the invention includes a message playback system and a timer. A control circuit allows the message playback system to be activated at desired times. In one method embodiment, the invention plays subliminal messages during at least one interval at a predetermined time after going to bed, and falling asleep. The invention may also play a message a predetermined time before waking.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a subliminal message machine with timer;

FIG. 2 shows an alternative embodiment of a subliminal message machine;

FIG. 3 is a flow chart of a play message algorithm; and

FIG. 4 is a flow chart of a subliminal message delivery algorithm (the delivery algorithm).

### AN EXEMPLARY EMBODIMENT OF A BEST MODE

The invention provides inventive embodiments that allow subliminal messages to be delivered at the time of day when a person is most receptive—during sleep, and just after waking. The invention makes it possible for a subliminal message to be played for a predetermined period of time while a person is dropping off to sleep, during sleep, and for a short time before waking. In addition, the messages can be specifically synchronized with sleep patterns.

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment. Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning-” or “step” for—functioning- “in the claims section.

Exemplary Devices

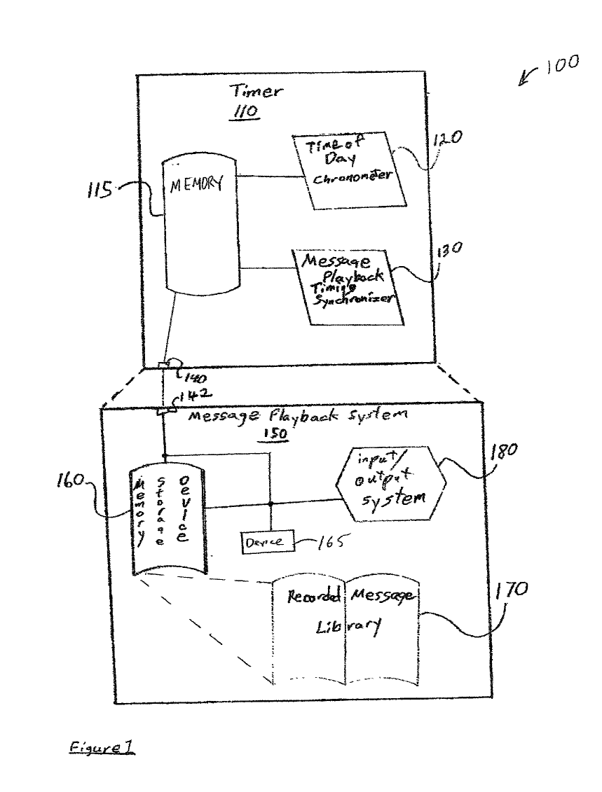

FIG. 1 illustrates a subliminal message system (the message system) 100 generally comprising a timer 110 and a message playback system 150. The timer 110 has a time of day chronometer 120 that maintains time-of-day and other calendar information. Preferably, the time of day chronometer 120 is embodied as a quartz timepiece that may access a memory 115 for storing time/day/week/month/year and other date-related information. The memory 115 also stores a play message algorithm that is enabled to drive a message playback system 150. In one embodiment, the invention is configured to provide the functionality of time and alarms traditionally associated with an alarm clock.

A message playback timing synchronizer (synchronizer) 130 can be used to instruct the message algorithm to time messages to play before and/or after a predetermined time period, such as an hour, thirty minutes, or some other time period, for example. Accordingly, the synchronizer 130 is typically user-interactive, but may be programmable. For example, the synchronizer 130 may accept a timing instruction from a specific message program, or from a memory device such as a pre-programmed memory stick.

The timer 110 is coupled to the message playback system 150 via a first port 140 and a second port 142. Although the ports 140, 142 are illustrated as modular plug-type connections, coupling between the timer 110 and the message playback system 150 could take any form that enabled the timing functions to communicate with the message playback functions. For example, the coupling between the timer 110 and the message playback system 150 could be part of an integral structure of a subliminal message system 100, a bus, or in an alternative embodiment could be a wireless connection.

The message playback system 150 includes a device 165. The device 165 provides a recording/playback medium for the message playback system 150. In one embodiment, the device 165 is a compact disk (CD) and compact disk player, in another embodiment, the device 165 is a cassette tape and cassette tape player. Other forms of devices are also be provided with the invention, such as RAM, ROM, or volatile memory.

As messages are stored or played on a device 165, they are stored on a memory storage device 160, and a recorded message library (the library) 170 may be built in separate memory, or as part of the memory storage device 160. Thus, the library 170 is a repository for at least one recorded message. Preferably, over time, as a user listens to more and more messages, the library 170 becomes a customized repository of messages that have particular significance and use to the user of the subliminal message system 100. Although not illustrated, it is appreciated by those of ordinary skill in the art that a processor, such as a DSP or a computer processor, may be used (via coupling to the memory, with direct or bus connections to the various components or systems) to implement logical and programming operations needed to activate the invention.

An input/output system (the I/O system) 180 provides various means for communicating with the subliminal message system 100, both electronically, and via human interaction. In one embodiment, operative functions such as visual displays and entry keys (or buttons) allow a user to set times for playing specific messages, and to view when messages are scheduled for play. In one embodiment, the I/O system 180 provides for the systems needed to enable wireless communication so that a message may be remotely loaded into the subliminal message system via a wireless system such as a cell phone system (such as CDMA 3G, for example), a pager system (such as CDPD, for example), a wireless local area network (IEEE 802.11b, for example), or another wireless system. These wireless systems may also transmit commands to control when the messages play, which message plays, or any other device/system command. Although not illustrated, it is appreciated by those of ordinary skill in the art that a wireless embodiment of the invention includes at least a receiver and preferably a transceiver.

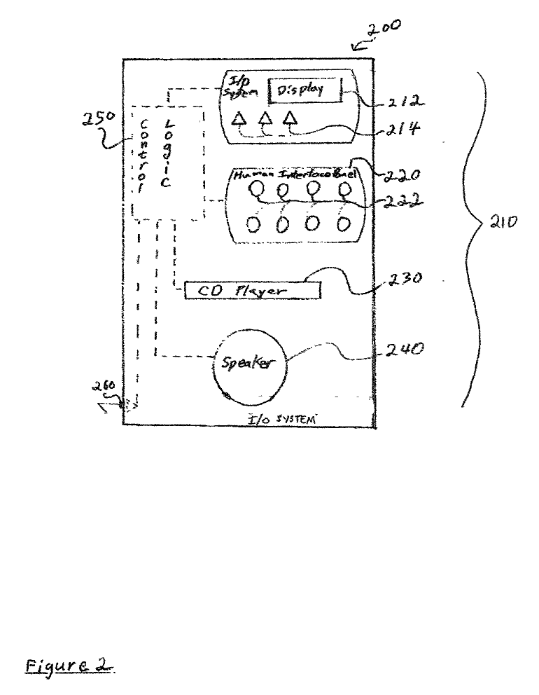

One can gain a better understanding of functionality of the invention by reviewing an illustration of user inputs/output. FIG. 2 shows an alternative embodiment of a I/O system 200, particularly emphasizing I/O system components that involve user interaction.

The input/output (I/O) system 210 includes a display 212 which is preferably a plasma screen display, but could also be a LCD, or LED display, for example. The display 212 provides visual communication to the user and depicts parameters such as message(s) for playback, time, date, alarm set time, and message playback time. In an alternative embodiment, the display 212 is adapted to receive a user's tap(s) as an interactive screen.

In one embodiment, a plurality of situational indicators 214 illuminate to provide information about the status of various functions. For example, a first indicator light may indicate that an automatic message playback mode has been selected. A second indicator light could indicate that a new message is being transferred from the library to the memory storage device. Other indicators may indicate additional functions as needed by those skilled in the art to provide desired functionality. Of course, although three indicators are shown, there could be more or fewer as needed by an embodiment of the invention.

A human interface panel 220 provides a plurality of entry keys (buttons) 222 that provide the machine 200 additional means to receive programming input. The entry keys 222 may receive input to select a time to play a message, may activate an automatic playback feature, may change the date/time, or may receive inputs for various other functions, for example. In one embodiment, the entry keys 222 may represent alphanumeric keys.

Other means of user input are provided. In a preferred embodiment, a memory storage device is a CD player which includes a slot 230 for receiving a CD which may maintain a message. In an alternative embodiment, the invention is coupled with needed systems to provide a functional CD player for the user. Of course, any other form of memory storage may provide a means for storing a message, such as a cassette tape, a cartridge, a memory stick, or RAM, for example.

Preferably, a speaker 240 is used as an audio output device. The volume of the speaker is user-controllable, and may be adjusted based on the message or on the particular receptive state of the user. However, other output devices are also usable with the invention, such as scent devices or vibrating/humming devices (which are reported to create a physiologically receptive mental state), for example.

A control logic 250 may integrate the input/output systems, and may include the algorithms needed to target specific sleep states for message playback to have a greater subliminal influence. In one embodiment, the control logic 250 includes a DSP, but could also provide a computer processor, such as a strong arm processor, for example. Also provided in the present embodiment, a modular interface 260 is provided to integrate the I/O system 200 to other devices in the message playback system 150, such as the memory storage device 160. In one embodiment, the modular interface 260 is an RJ11 telephone jack that allows the machine to receive internet downloads of recorded messages. In other embodiments, this interface could take other forms including an antenna connection for receipt of cellular transmissions, a cable connection for coupling with a computer, or a cable connection for coupling with a peripheral CD storage device, for example.

Exemplary Methods

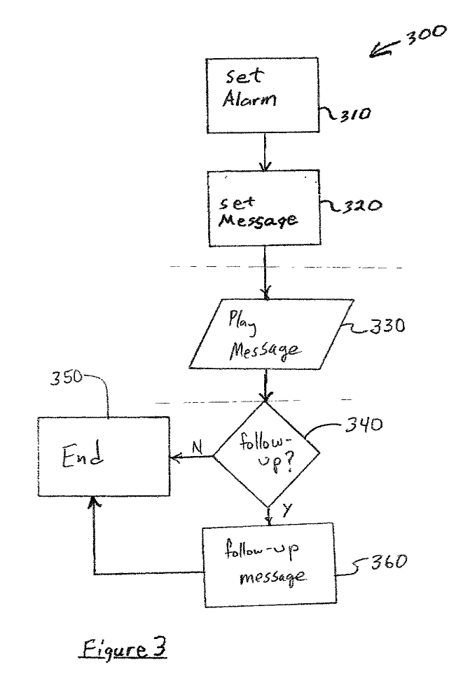

The invention can be understood in one embodiment as a method of delivering a subliminal message. Accordingly, FIG. 3 is a flow chart that shows how a play message algorithm 300 targets a message to play a subliminal message, targeted at specific sleep states. In the play message algorithm 300, a set alarm act 310 initiates the process of targeting specific sleep states. During the set alarm act 310 an input (typically a user-initiated input) is received by the subliminal message system. The input of the set alarm act 310 typically sets an alarm that is used to wake a user from sleep.

Then, the play message algorithm 300 proceeds to a set message time act 320. The set message act 320 tags a previously stored message in memory and designates that message to play at a selected time, or during a detected brain state or sleep state. Preferably, the time is a predetermined time before the alarm is set to go off. The predetermined time may be user-set, or may be automatically set. In either event, one goal of the message is to play at a predetermined time prior to the sounding of the alarm so that the message will play during a time when a user's brain is in the beta-wave state. Alternatively, the subliminal message system may be connected to a device that detects beta waves. In this embodiment, the subliminal message machine may begin playing the message when it is detected that the brain of the user is in the beta wave state.

Next, when the particular time that is designated in the set message act 320 is reached, or when the conditions designated in the set message act are detected, the play message algorithm 300 proceeds to play the designated message in the play message act 330. After playing the message, the play message algorithm 300 proceeds to either wait until a follow-up message is to be played, or, if no follow-up message is part of the subliminal message program, the play message algorithm 300 proceeds to an end act 350 where the play message algorithm prompts the user for message replay.

Accordingly, in a follow-up query 340, the play message algorithm 300 checks to see whether the user has setup a message for follow-up play, or if there is a follow-up message to play as part of a subliminal message program. For example, a subliminal message program may include an additional message to play when a user wakes up. Thus, more effective subliminal message programs can be implemented when the system provides a subliminal message while one is sleeping and a subliminal message while one is awake. Thus, if the follow-up query 340 detects that no follow up message is provided, then the play message algorithm 300 proceeds with the “n” decision to the end act 350. Similarly, when a follow-up message is part of the subliminal message program, then the play message algorithm 300 continues to a play follow-up message act 360. The play follow-up message act 360 may include a single follow-up message, or may include a plurality of follow-up messages that may be played while the user is asleep or awake. In addition, the play follow-up message act 360 provides further message reinforcement, in some applications, by providing for further scheduling of the message.

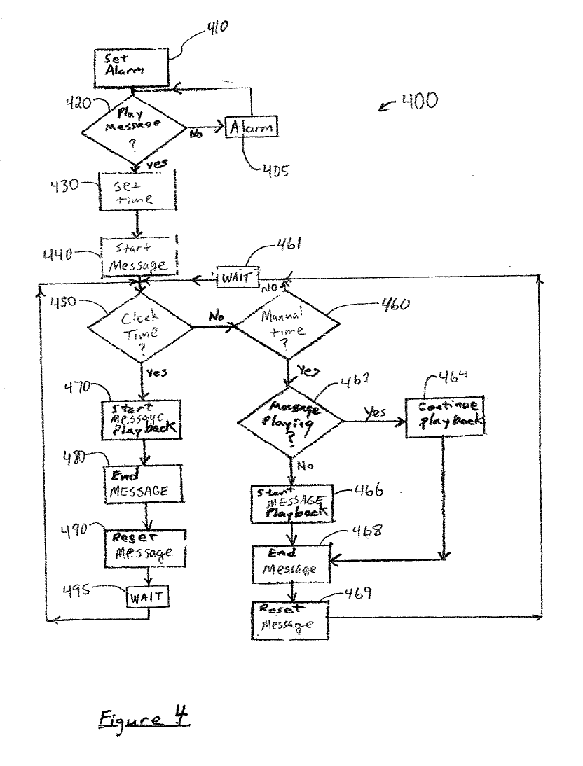

In FIG. 4, a delivery algorithm 400 illustrates how one embodiment of the invention targets the beta brain-wave state of sleep. The beta brain-wave state often occurs just prior to awaking. Accordingly, in the delivery algorithm 400 the subliminal message system targets the beta brain-wave sleep state by timing a message to play thirty minutes prior to the time an alarm is set to go off. In other embodiments other sleep states can be targeted, or the beta-wave state can be target through other means. Other preferred times to play a subliminal message include immediately after going to bed (while “dozing off”), one hour after going to bed, or some other predetermined time period after retiring to bed, for example. It should be understood that sleep patterns vary by person, and that the predetermined time may be set in a manner that is customized for the user. Thus, a user may manually hit a button when they go to bed so that a message plays a predetermined period of time after they go to bed. Of course, if the subliminal message system can detect when a beta-state is achieved, the message plays at preselected intervals when that state is achieved.

Thus, in the delivery algorithm 400, a user enters a time for the alarm to go off in a set alarm act 410. Then, in a play message query, the user may select to turn the subliminal message on or off. If the user selects for the message to be “off” (or, if used as the default setting), then the delivery algorithm 400 ends and the subliminal message system functions as a typical alarm clock as indicated by the alarm act 405. If a message has not been selected for playback (via the alarm act 405), then the message algorithm continues to periodically check to see if the user request has changed to select automatic playback as indicated by the return arrow emanating from the alarm act 405. However, if a user selects for a subliminal message to play in the play message query 420, then the delivery algorithm 400 proceeds to a subtract time act 430.

The subtract time act 430 targets a preselected sleep state. Next, the delivery algorithm 400 will activate a section of modular code that defines a sleep-state targeting model that was pre-selected by the user. In the present method, assume that a user has determined that a particular is best delivered during a sleep state that is achieved about 30 minutes prior to waking. Then the user will have preselected the desired message to play 30 minutes prior to waking. In one embodiment, the play message auto on act 420 can activate other code modules as desired by the user to target other sleep states, and may be manipulated or programmed to play a plurality of messages. Thus, the set time act 430 determines the time or times in which to play a selected message or messages. Accordingly, the time(s) for playing the message(s), and optionally, the messages themselves, are passed to memory in a start message act 440, that stores a time(s) to start the message(s).

A message may be initiated by a clock time or by a predetermined period of time passing since a user initiated button depression to indicate that they are headed to bed. Thus, next, in a start message=clock time query (the query) 450 a comparison is performed (preferably at the start of each minute) between the time of day and a time that the message is to play. If the query 450 does not detect that the selected clock time is reached, the system proceeds to a manual time query 460 to see if the user has depressed the manual play button, indicating that they went to bed at the time the manual play button was pressed (so that a message will play at a selected time after the user manually indicates that they have gone to bed).

If it is determined in the manual time query 460 that the manual play button was not pressed, the delivery algorithm 400 proceeds to a wait act 461. In the wait act 461 the delivery algorithm 400 sit idle until a next event triggers the next query 450—exemplary events include reaching a predetermined point in time, such as a whole number of a minute, or an interrupt is initiated, such as the pressing of a play message button. When the trigger point occurs, the message algorithm returns to the next query 450. However, if the manual time query 460 determines that the manual play button has been depressed then, the delivery algorithm 400 continues processing the manual play request.

It is desirous to prevent multiple messages from playing simultaneously. Accordingly, before a manual play request is executed, the delivery algorithm 400 checks to see if a message is currently running. Accordingly, in message playing query 462, the delivery algorithm 400 checks to see if a message is currently playing. If a message is playing as indicated by the “yes” decision path, then the continue playback 464 act is performed, which allows the current message to continue without interruption. Then, when the current message is complete, the delivery algorithm 400 continues to an end message act 468 in which electrical continuity to the speaker is ended if no further messages are scheduled for play.

Returning briefly to the playing message query 462, if it is determined that no message is playing, the delivery algorithm 400 continues to process the manual play request by initiating the start message playback act 466, which plays the designated message. When the message is complete, the end message act 468 is then performed. If no further messages are designated to play in the end act 468, the system continues to function as an alarm clock (as in the alarm act 405, though no “return arrows are shown to prevent cluttering the diagram). If more messages may be scheduled to play, the end message act 468 performs no substantive function and merely passes the delivery algorithm 400 to the reset message act 469, which returns the message algorithm to the wait act 461.

If the next query 450 finds that the start time set by the user equals the present time, then the delivery algorithm 400 proceeds to the start message playback act 470 in which the designated subliminal message (the message) is played (thus, at the targeted sleep time, to reach the targeted sleep state). After the message is played, an end message act 480 ends the playback, and switches off power to the speaker when it is detected that no further messages are scheduled to play. If no further messages are designated to play, the system continues to function as an alarm clock (as in the alarm act 405, though no “return arrows are shown to prevent cluttering the diagram). If further messages are detected, then a reset message act 490 takes the delivery algorithm 400 to a wait act 495, where the delivery algorithm 400 sit idle until a next event triggers the next query 450.

Of course, although FIG. 4 describes targeting a sleep state based on time in the sleep cycle, many other message delivery options are available. For example, a message may be directed to play when a specific stage in a sleep cycle is detected. In addition, the choice of subliminal message is obvious to those with ordinary skill in the art—such as smoking cessation programs, weight loss programs, and self esteem programs, for example.

Accordingly, the invention provides methods, systems and devices that couple delivery of a subliminal and/or audible message with a predicted point in the sleep cycle, or a specific time when one is awake and receptive to an audible message, such as just after waking. Accordingly, one may have both subliminal and conscious exposure to messages at times that make systematic exposure to the messages a manageable part of a personal development program. Of course, a personal development program may include either subliminal or audible messages, or both, and may play message at times, volumes, and intervals as needed to effectively motivate a user.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A subliminal message machine with timer (the machine), comprising:
a timer adapted to communicate with a message playback system;
a message playback system communicatively coupled to the timer, the message playback system comprising
a device adapted to receive recorded messages, and adapted to enable a message to play on the message playback system; and
an input/output system coupled to the device.

2. The machine of claim 1 further comprising a memory storage device in communication with the device.

3. The machine of claim 2 wherein the memory storage device maintains a recorded message library.

4. The machine of claim 1 wherein the device is a CD player.

5. The machine of claim 1 wherein the timer further comprises a memory, the memory having a message algorithm.

6. The machine of claim 5 wherein the timer further comprises a time of day chronometer coupled to the memory.

7. The machine of claim 5 wherein the timer further comprises a message playback timing synchronizer coupled to the memory.

8. The machine of claim 1 wherein the input/output system further comprises a LCD display.

9. The machine of claim 5 wherein the message algorithm activates the message playback system at a predetermined time preceding an alarm.

10. The machine of claim 1 wherein the message playback system further comprises a receiver coupled to the memory storage device for accepting messages from a network.

11. The machine of claim 10 wherein the network is the Internet.

12. The machine of claim 10 wherein the network is a wireless network.

13. The machine of claim 1 wherein the input/output system further comprises a control logic in communication with a memory storage device.

14. The machine of claim 3 wherein the message library maintains a subliminal message.

15. The machine of claim 3 wherein the recorded message library is adapted to receive a message from a second recorded message library that is located remotely from the machine.

16. The machine of claim 1 wherein the timer maintains a play message algorithm.

17. A method of playing a subliminal message, comprising:
receiving a designated time for an alarm to sound;
automatically setting a message to play at predetermined time based on the time for the alarm to sound; and
playing the message.

18. A method of playing a subliminal message, comprising:
receiving an indication at a time that a user is going to sleep;
automatically setting a message to play at predetermined time based on the time the indication is received; and
playing the message.

19. The method of claim 18 wherein the message is a subliminal message.

20. The method of claim 18 wherein the indication is generated by detecting that a person has entered a beta-wave sleep state.
